(19) United States
(12) Patent Application Publication
(10) Pub. No.: US 2018/0319053 A1
(43) Pub. Date: Nov. 8, 2018

(54) METHODS FOR MAKING MONOLITHIC INJECTION MOLDED PLASTIC PARTS

(71) Applicant: Moxietec, LLC, Cochranton, PA (US)

(72) Inventors: Jason L. Minnich, Cochranton, PA (US); Travis J. Biggs, Cochranton, PA (US)

(21) Appl. No.: 16/032,993

(22) Filed: Jul. 11, 2018

Related U.S. Application Data
(63) Continuation of application No. PCT/US2018/014200, filed on Jan. 18, 2018.
(60) Provisional application No. 62/451,625, filed on Jan. 27, 2017.

(51) Int. Cl. B29C 44/42; B29C 44/02; B29C 45/50; B29C 44/34

(52) U.S. Cl. CPC B29C 44/422; B29C 44/02; B29C 45/0013; B29C 45/50; B29C 44/3446; B29C 44/428

(57) ABSTRACT

A monolithic injection molded plastic part including an interior core, a surface formed as a monolithic structure with the interior core, and a distribution of hollow cells formed within the interior core during an injection molding process from a blowing agent and methods for making the same are provided. Such methods include preparing a mixture of unmelted plastic resin, filler agent, and blowing agent, melting the mixture into a viscous combination using a standard injection molding machine, injecting a set amount of the viscous combination into a hollow cavity of an injection mold secured within the standard injection molding machine, and holding the set amount of the viscous combination in the hollow cavity at a low pressure for a hold time until the viscous combination sets into a monolithic structure at least partially filling the hollow cavity and the blowing agent forms a distribution of hollow cells throughout the monolithic structure.

### CROSS REFERENCE TO RELATED APPLICATIONS

The present application claims priority from and the benefit of International Patent Application No. PCT/US2018/014200 filed Jan. 18, 2018 entitled “Monolithic Injection Molded Plastic Parts And Methods For Making Same,” which claims priority from and the benefit of U.S. Provisional Patent Application No. 62/451,625 filed Jan. 27, 2017 entitled “Expanded Foam-like Injection Molded Plastic.” Both applications are hereby incorporated herein by reference in their entirety.

### FIELD

The present invention relates generally to injection molded plastic parts. More particularly the present disclosure relates to monolithic injection molded or expanded foam like injection molded parts and a method of manufacture for said parts on an injection molding machine.

### BACKGROUND

Known methods for manufacturing plastic injection molded parts produce thin walled plastic parts having a hollow center cavity. The size of such molded parts becomes an issue as the parts get larger. In order to prevent collapse of larger cross-section area parts, it is standard practice to add internal supports or ribs. The ribs and internal supports increase the cost and complexity of the injection molding process. One known alternative method to the traditional method for making thin walled parts can create thicker foamed plastic parts using expensive special equipment. However, this method is still limited in the overall cross-section that can be generated for through formed foamed out parts. Such parts are known to be limited to around less than ½ of an inch in plastic thickness. Such methods have additionally demonstrated only a modest 20-40 percent decrease in part density when compared to a completely solid plastic part of the same shape and size.

U.S. Pat. No. 2,903,388 to R. Jonke and J. Lintner, entitled “Process for injection-molding reinforced or stiffened parts in plastic material,” is an example of the old methodology of using injection molding equipment for creating thin walled plastic parts having internal “honeycomb” reinforcement ribs. That differs from the methods and parts disclosed herein. Specifically, the parts and methods disclosed herein create a suspended aerated plastic support mass-structure inside the entirety of mold cavity thereby eliminating the need to have support ribs designed into the part mold. Jonke et al. reflects making thin walled parts and how to support them using thin walled support ribs which have to be tooled into the part mold, which creates a cost increase in tooling. Molded parts as disclosed in the present disclosure can be of an open shape design, unheard of in the injection molding industry. Jonke et al. teaches that plastic parts must be thin walled, and the wall must be held up or supported using ribs tooled into the mold, which creates extended tooling time. The parts and methods disclosed herein offer a huge advantage to drastically reduce mold design and tooling cost by creating an open shaped mold.

For example, an open shaped mold as disclosed herein encompass the outer limit of the part being made resulting in a simpler style of mold to tool and build vs a thin walled part mold. The systems and methods disclosed herein allow for molten plastic to expand and fill a large inner cavity of a mold to create the internal makeup of the part which simplifies mold design compared to an identical shape made as a thin walled plastic part. For example, a typical thin walled plastic part either would have to be made in a mold at least twice the size of the open shaped mold disclosed herein because there would have to be two thin walled halves made with inner wall support ribbings, slides to allow multiple directional openings of the mold to account for undercuts in complicated shapes, complicated cooling line designs, and connection areas for the two halves to be joined/glued/plastic welded together after they are removed from the mold. The systems and methods disclosed herein allow parts to be created in molds drastically smaller and also allow for reduced secondary operations of joining two thin walled plastic parts together which saves time and money. The systems and methods disclosed herein also allow for parts to have prolonged life compared with thin walled plastic parts that include two distinct halves that can potentially fall apart or come unbound during use or old age.

Jonke et al. U.S. Pat. No. 2,903,388 also teaches that mold temperatures are above the temperature of the molten plastic in order for the plastic to spread out and fill the mold. The parts and methods described herein preferably do the opposite. Illustratively, the molds of the herein-disclosed parts and methods may be cooled to between 35-50 degrees F. while the plastic injected into the mold is around 385 degrees F. This preferred mode of operation is not taught or suggested by this referenced patent. Additionally, the parts and methods disclosed herein preferably include a water chiller unit available to individually control the mold temperatures for each side of the mold, allowing the plastic in the mold to be cooled differently depending on the shape and size of the part. For example, a part that is the size of a shoe box with a round side and the opposite side having a flat side may have each representative side of the mold utilize different temperatures to control the material properly based on its geometry. Furthermore, a small part such as a baseball sized part may have both sides of the mold be temperature controlled at the same temperature due to the part size being smaller and with a more symmetrical geometry. The parts and methods disclosed herein offer a means to make a molded part rigid by creating a suspended aerated mass of plastic within the outer wall or surface rather than thin walled rib structures discussed in Jonke et al. and relied on by plastic technicians, engineers and professors in crafting modern plastic parts.

U.S. Pat. No. 5,667,740 by S. Spydevold is entitled “Process for the production of products of light cellular plastic with closed cells” and is an example of multiple prior art molding processes that differ from the methods and parts disclosed herein. For example, Spydevold discusses structural foam molding which has limitations as to part appearance and requires complicated post molding treatments. The preferred methods disclosed herein provide high level surface details with minimal cooling expense by placing parts in water or on a rack with a fan moving air over the parts. Furthermore, Spydevold discusses a second type of structural foam molding known as high pressure structural foam molding, where an expensive and complicated mold tool is required and there are a lot of moving parts to allow the foam to fill the part fully. Even so, the parts made with low and high pressure structural foaming methods are still thin walled parts with support ribbing. Although low pressure structural foaming methods do offer part reduction in weight, only a reduction up to 40% of the weight is possible whereas the methods disclosed herein have shown up to 75% weight reduction. Additionally, high pressure structural foam molding, as noted in Spydevold, has limited density reduction.

Spydevold further discusses using an after-molding process of an “expansion mold” to control the expansion of the molded part to stop distortion which is not needed for the methods described herein. The elimination of extra molds provides a big cost savings over the prior art methods. Spydevold also employs high pressure surface cooling which the preferred methods described herein do not use. Rather, the present methods use a large amount of venting (see FIG. 2) cut into the, mold tool around the perimeter of the mold to allow no pressure inside the mold cavity throughout the process of molding to maximize the ability of the expansion of the plastic batter, which allows the part specific plastic batter to expand inside the mold under zero pressure.

Furthermore, Spydevold discusses mold temperatures and part temperatures much higher than what is used in the preferred methods disclosed herein. Typically the methods disclosed herein employ a much lower mold temperature that is between 34-50 degrees F. However, other higher temperature ranges between 75-80 degrees F. have been used. In contrast to the discussed prior art patent, the methods disclosed herein may produce a finished part out of the mold that is relatively cool to the touch and requires no (or very minimal) after-molding steps to control additional expansion, warping, or sinking. This feature allows the part to be easily moved to the next step in the part production process in less time, which reduces cost. The lower heating requirement of the preferred methods disclosed herein may also allow the plant to improve its temperature controls of the plant environment due to the drastically reduced heat radiation coming off the molded parts. This yields a possibility for reduced plant utility bills in addition to safety benefits of handling of the parts out of the mold not being as hot as other parts made using other methods.

In view of the above, there is continuing, ongoing need for improved methods of making injection molded plastic parts that can be manufactured using conventional injection molding machines, include through-formed monolithic interiors and exteriors with thicknesses greater than 0.5 inch, and can have over 40 percent less density than a completely solid plastic part of the same shape and size.

An object of the invention is to use standard injection molding equipment to make a molded object having a size of one foot or more, where the molded object is substantially fully filled instead of being completely hollow.

Another object of the invention is to produce a molded part that is appreciably less dense than a solid plastic part but which exhibits high strength.

Another object of the invention is to produce a monolithic injection molded plastic part comprising an interior core and a surface formed as a monolithic structure with the interior core, where the interior core substantially fills the entire surface and includes a distribution of hollow cells formed from a blowing agent during an injection molding process.

Another object of the invention is to produce a part on an injection molding machine using a method of preparing a mixture of unmelted plastic resin, talc or glass bubbles, and blowing agent, loading the mixture into the injection molding machine, melting the mixture into a viscous combination in the injection molding machine, securing two halves of an injection mold between a first platen and a second platen of the standard injection molding machine to form a hollow cavity, injecting a set amount of the viscous combination into the hollow cavity, holding the set amount of the viscous combination in the hollow cavity at a low pressure for a hold time until the viscous combination sets into a monolithic structure at least partially filling the hollow cavity and the blowing agent forms a distribution of hollow cells throughout the monolithic structure, cooling the two halves of the injection mold, and ejecting the monolithic structure from the injection mold.

### SUMMARY

In accordance with disclosed embodiments, a monolithic injection molded plastic part may be provided. The monolithic injection molded plastic part may include an interior core and a surface formed as a monolithic structure with the interior core. The interior core may substantially fill the entire surface and include a distribution of hollow cells formed from a blowing agent during an injection molding process.

In accordance with disclosed embodiments, a method for manufacturing an injection molded plastic part may be provided. The manufacturing method may include preparing a mixture of unmelted plastic resin, filler agent, and blowing agent, loading the mixture into an injection molding machine, and melting the mixture into a viscous combination in the injection molding machine. The manufacturing method may also include securing two halves of an injection mold between a first platen and a second platen of the injection molding machine to form a hollow cavity. The manufacturing method may also include injecting a set amount of the viscous combination into the hollow cavity and holding that set amount in the hollow cavity at a low pressure for a hold time until the viscous combination sets into a monolithic structure at least partially filling the hollow cavity and the blowing agent forms a distribution of hollow cells throughout the monolithic structure. The manufacturing method may also include cooling the two halves of the injection mold and ejecting the monolithic structure from the injection mold.

In accordance with disclosed embodiments, an additional or alternative method for manufacturing an injection molded plastic part may be provided. The method for manufacturing an injection molded plastic part may include securing a mold into an injection molding machine. A first half of the mold may be secured to a movable platen. The method for manufacturing an injection molded plastic part may also include heating multiple heating zones of a barrel of the injection molding machine to respective set temperatures and after the respective heating zones achieve the respective set temperatures, feeding a mixture of unmelted plastic resin, blowing agent, and talc or glass bubbles into the barrel in order to allow plasticization of the mixture into a viscous combination. The method for manufacturing an injection molded plastic part may also include beginning a mold cycle by rotating a feed screw inside the barrel to an initial shot size, moving the movable platen to a first set point fully opening the first half of the mold and a second half of the mold, moving the nozzle forward until the nozzle is seated up against a circular sprue of the mold, moving the movable platen from the first set point to a second set point at a first rate and a first pressure, moving the movable platen from the second set point to fully closed at a second rate and a second pressure, and pushing the screw ahead toward the nozzle at a third rate and a third pressure for a first preset time period to inject the viscous combination into the mold until the mold is at least partially filled. The method for manufacturing an injection molded plastic part may also include, when the screw reaches a cutoff distance from the nozzle, holding the first half of the mold and the second half of the mold open at a distance for a second preset time period at a low pressure to allow the blowing agent to expand the vicious mixture and fill out the rest of the mold. The method for manufacturing an injection molded plastic part may also include cooling the mold for a predetermined time and, following expiration of the predetermined time, ejecting a part formed from solidifying of the expanded viscous mixture from the mold.

In accordance with disclosed embodiments, a part may be provided. The part may include a first monolithically molded plastic piece having a first interior core and a first surface formed as a monolithic structure with the first interior core. The first interior core may substantially fill the first surface and include a first distribution of hollow cells formed from a blowing agent during an injection molding process. The part may also include a second monolithically molded plastic piece having a second interior core and a second surface formed as a monolithic structure with the second interior core, wherein the second interior core substantially fills the second surface and includes a second distribution of hollow cells formed from a blowing agent during an injection molding process. The part may also include a fastener having a first end coupled to the first distribution of hollow cells inside the first monolithically molded plastic piece and a second end coupled to the second distribution of hollow cells inside the second monolithically molded plastic piece.

In accordance with disclosed embodiments, a molded plastic part formed on a plastic injection molding machine may be provided. The molded plastic part may include an outer surface and a suspended and aerated plastic support mass-structure inside and substantially filling completely the outer surface. Interior support ribs to support the outer surface may be omitted as unnecessary.

In accordance with disclosed embodiments, a molded plastic part may be provided. The molded plastic part may include a suspended and aerated plastic support mass-structure inside and substantially filling completely an outer surface. The molded plastic part may be made on a plastic injection molding machine.

### FIGURES

FIG. 1 is a schematic view of a standard injection molding machine according to disclosed embodiments;

FIG. 2 is a schematic view of a portion of an injection mold according to disclosed embodiments;

FIG. 3A is a flow diagram for a method for making an injection molded plastic part according to disclosed embodiments;

FIG. 3B is a flow diagram for a method for making an injection molded plastic part according to disclosed embodiments;

FIG. 4 is an exploded view of a monolithic injection molded plastic part according to disclosed embodiments;

FIG. 5 is an exploded view of a monolithic injection molded plastic part according to disclosed embodiments; and

FIG. 6 is a sectional view of part having multiple monolithic injection molded plastic pieces joined together according to disclosed embodiments.

### DESCRIPTION

While this invention is susceptible of embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

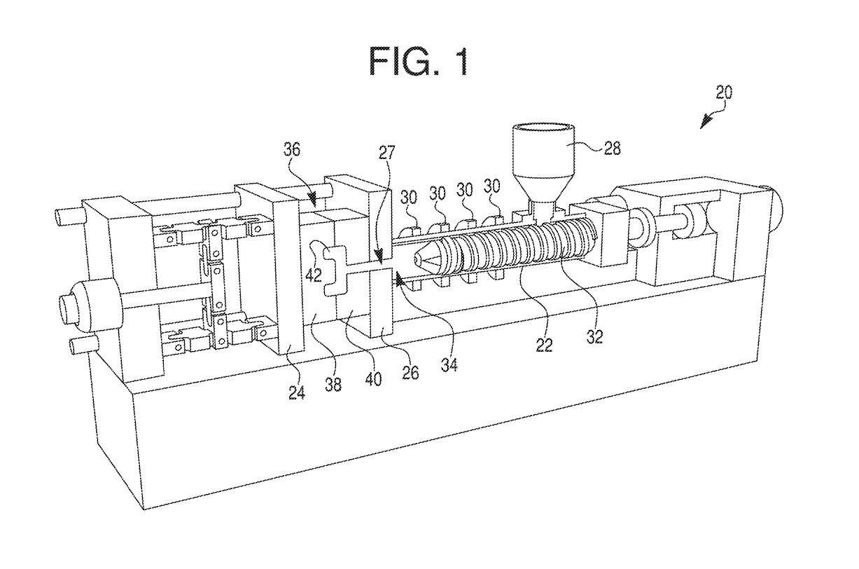

Referring first to FIG. 1, a standard injection molding machine 20 is shown. The standard injection molding machine 20 may include a barrel 22, a first or movable platen 24, a second or fixed platen 26, a feeder mechanism 28, and a barrel heating mechanism 30. The barrel 22 may include an internal feeder screw 32 and a nozzle 34. In some embodiments, the barrel 22 may be sized up to 80 ounces to allow for large shot sizes needed to fill large cavity molds. The first platen 24 and second platen 26 may secure an injection mold 36 to the standard injection molding machine 20. The injection mold 36 may include a first half 38 secured to the first or movable platen 24 and a second half 40 secured to the second or fixed platen 26. In some embodiments, a sprue interface or cavity 27 for coupling the injection mold 36 to the nozzle 34 may be formed in the fixed platen 26. The first half 38 and the second half 40 may form a hollow cavity 42. In some embodiments, the feeder mechanism 28 may include a gravity fed hopper. In some embodiments, the barrel heating mechanism 30 may include individual heating bands that are separately controllable to heat respective heating zones of the barrel 22 to different temperatures.

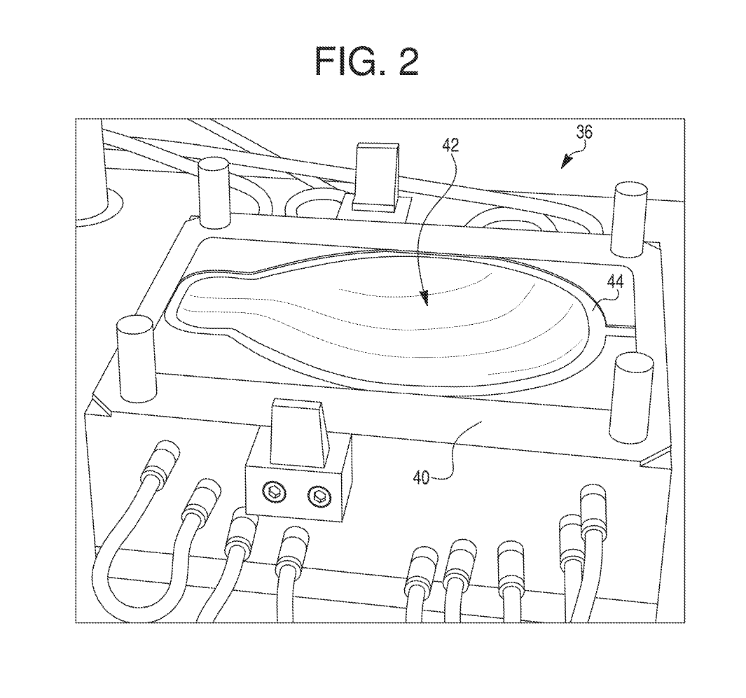

FIG. 2 shows a partial schematic representation of injection mold 36. Second half 40 may include a large amount of venting 44 cut around the perimeter of the injection mold 36 to limit the pressure inside the mold cavity throughout the process of molding, thereby to facilitate and promote the expansion of the plastic material injected into the hollow cavity 42. In some embodiments, the venting 44 may include a ring of slightly lower profile cutaway area around the injection mold 36 with linear cut slots protruding outward toward the sides of the injection mold 36 to direct the hot air out when the plastic material is shot into the hollow cavity 42.

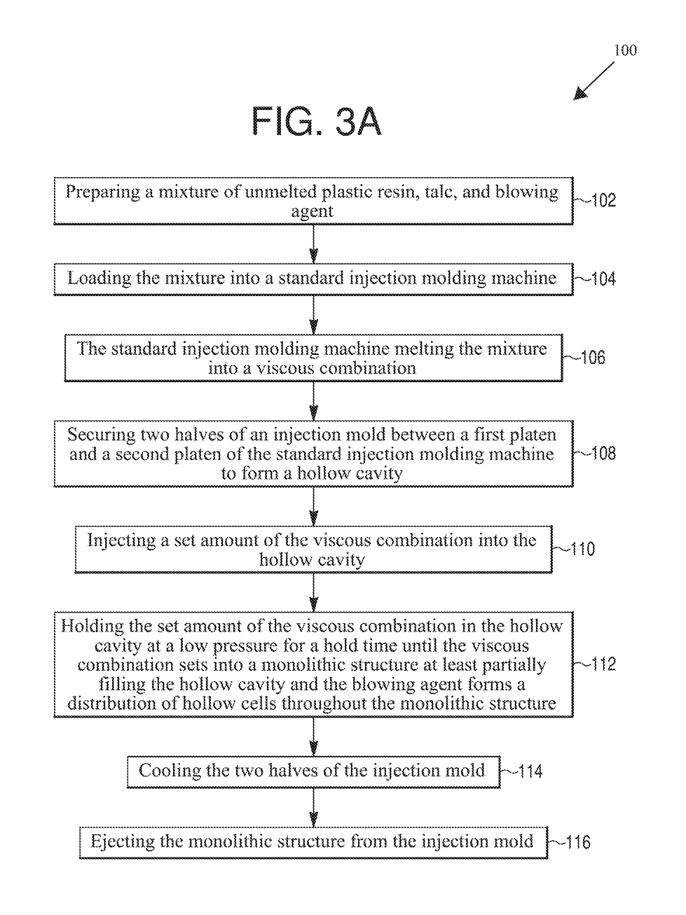

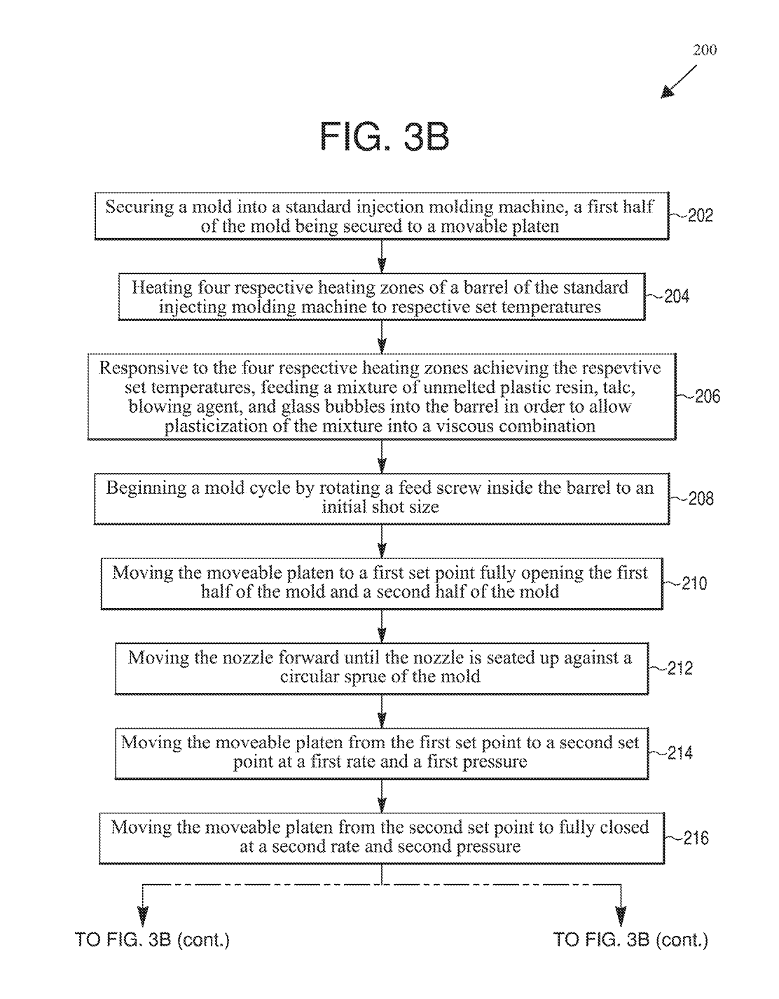

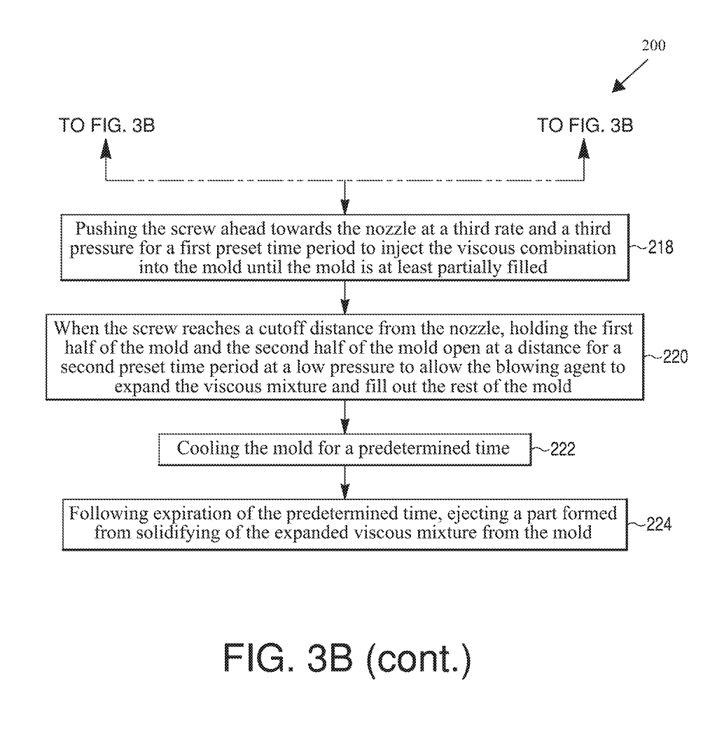

FIG. 3A shows a flow diagram for an illustrative method 100 for manufacturing an injection molded plastic part using the standard injection molding machine 20. A mixture of unmelted plastic resin, filler agent such as talc, and blowing agent may be initially prepared as indicated in step 102. In some embodiments, the talc may be approximately 15 percent of the mixture by weight, and the blowing agent may be between 1 and 5 percent of the mixture by weight. In some embodiments, Hydrocerol® BIH70 may be used as the blowing agent. The Hydrocerol® BIH70 may be added at the machine using a mixer or may be premixed into the parent plastic material from the distributer. Hydrocerol® BIH70 may have an additive concentration of 70% (±3.5%), a bulk density of 47 lbs/cf (±7 lbs/cf), a moisture content of less than 1.0%, and a pellets per gram concentration of 60-77/gram. In some embodiments, an amount of glass bubbles may be substituted for some or all of the talc as the filler agent within the mixture to enhance the properties of the blowing agent. Use of the glass bubbles in place of the talc may also reduce the weight of the finished part by approximately 20-30 percent. In some embodiments, the glass bubbles may be 3M Glass Bubbles iM16K grade, with a crush strength of 16,000 psi, a 90% minimum fractional survival, a 0.46 g/cc density, and a 20 micron particle size. A finished part may benefit from using the glass bubbles instead of talc to achieve a finished part that is solid and weighs less than a part with the same dimensions made using talc. For example, a part made out of harder polypropylene instead of low density polyethylene can be made to have the same finished density no matter if made using either two materials.

In some embodiments, the glass bubbles may be approximately 10 percent of the mixture by weight and the blowing agent may be approximately 1.5-2 percent of the mixture by weight. In some embodiments the blowing agent is a chemical type blowing agent. The unmelted plastic resin may be a mix of polymer materials or standard resin material for known plastic polymers including polypropylene, low density polyethylene, and high density polyethylene. Additional or alternative base materials may also be substituted or blended with those described above. Such materials may include, but are not limited to, acrylonitrile butadiene styrene (ABS), Nylon, fiber-reinforced plastic (FRP), and Rubber.

When present, the filler agent increases heat transfer of the molten plastic material with the mold, which allows for faster cooling and suspension of the plastic material as an aerated mass. Specifically, the talc and the glass bubbles fluff up the plastic mixture and increase the ability of the plastic mixture to fill space as the plastic mixture aerates and cools. The glass bubbles increase the heat transfer properties of the molten plastic material more than the talc, but are more expensive. The increased heat transfer properties may be desirable for applications creating larger cross sectional area parts that may otherwise fail without the filler agent or with the use of talc instead of the glass bubbles. For example, the larger the size of the finished molded part the greater the heat transfer may need to be to properly foam out the plastic mixture into the solid monolithic structure described herein. In some embodiments, the mixture may not include any filler agent such as the talc or the glass bubbles. The filler agent may be removed for parts having a smaller cross sectional area and requiring a denser finished structure. Removing the filler agent may increase the overall cycle time of the process and may result in added expenses.

As shown in FIG. 3A, the mixture may be loaded into the standard injection molding machine 20, as indicated in step 104. The standard injection molding machine 20 may melt the mixture into a viscous combination, as indicated in step 106. The viscous combination may include the plastic resin in a partially or totally melted state, the filler agent, and the blowing agent. The two halves 38 and 40 of the injection mold 36 may be secured between platens 24 and 26 to form the hollow cavity 42, as indicated in step 108. The size and shape of the hollow cavity 42 may dictate the size and shape of any resulting plastic part formed using the injection mold 36, and as such the injection mold 36 may be customized to produce completed parts of various thickness and shape. A set amount of the viscous combination may be injected into the hollow cavity 42, as indicated in step 110. The set amount of the viscous combination may be dependent on the dimensions of the hollow cavity 42. For example, the set amount when the hollow cavity 42 has a large volume will be greater than when the hollow cavity 42 has a smaller volume. In some embodiments, the viscous combination may be injected into the hollow cavity at a flow rate of 5.79 in/sec and a pressure of 2,000 psi for a time period calculated based on the set amount. In some embodiments, the time period is 2.35 seconds. In some embodiments, the set amount of the viscous combination may be injected into the hollow cavity at multiple points. Injecting the viscous combination at multiple points may allow for an even distribution of the viscous combination within the injection mold 36 when the hollow cavity 42 has elongated dimensions. The use of multiple injection points may also facilitate even solidification and foaming out of the viscous combination into a monolithically structured part where injecting from a single entry point would prevent the viscous material from reaching the end of the hollow cavity 42 prior to the blowing agent beginning to foam out the melted plastic resin. In some embodiments, the feeder screw 32 may be rotated back to a full shot size of the standard injection molding machine 20 prior to melting the mixture into the viscous combination. In some embodiments, a back pressure of between 5 and 20 psi, and preferably 15 psi, may be applied within the barrel 32 following the injection of the set amount of the viscous combination into the hollow cavity 42. Conventional thin wall plastic parts are manufactured using a back pressure around 100-150 psi or even 400 psi for applications using certain colored resins. Using a lower back pressure when compared to the typical manufacturing process for thinned walled plastic parts may allow the blowing agent to better foam out of the viscous material into the monolithically structured part.

Furthermore, as shown in FIG. 3A, the set amount of the viscous combination may be held in the hollow cavity at a low pressure for a hold time until the viscous combination sets into a monolithic structure at least partially filling the hollow cavity 42 and the blowing agent forms a distribution of hollow cells throughout the monolithic structure, as indicated in step 112. Holding the viscous material at a low pressure allows the viscous combination to solidify into a through formed monolithic part without a hollow center cavity. The blowing agent may form the hollow cells by foaming out the rest of the viscous combination as the melted plastic resin solidifies. The amount and size of each of the hollow cells may be varied based on the amount of the low pressure applied to the injection mold 36. The higher the value of the low pressure the smaller and denser the resulting hollow cells will be. In some embodiments, the low pressure is between 3 and 8 psi and the hold time is between 20 and 60 seconds. Preferably the low pressure is 5 psi and the hold time is 40 seconds. Additionally or alternatively, the low pressure may be 30 percent of a peak flow rate for injecting the set amount of the viscous combination into the hollow cavity 42. In some embodiments, the two halves 38 and 40 of the injection mold 36 are positioned to form a gap in between the two halves 38 and 40 while holding the set amount of the viscous combination in the hollow cavity 42. In some embodiments, the gap may be between 0.005 and 0.015 inches and preferably 0.01 inches. In embodiments where the viscous combination includes glass bubbles, the glass bubbles may act along with the blowing agent to foam out the melted plastic resin as it solidifies.

Furthermore, as shown in FIG. 3A, the two halves 38 and 40 of the injection mold 36 may be cooled, as indicated in step 114. Some embodiments may arrange for the first half 38 and the second half 40 to be cooled independently. For example, 100 degree Fahrenheit water may be run through the first half 38, and 50 degree Fahrenheit water may be run through the second half 40. The differential cooling allows for specific targeting of portions of the injection mold 36 that by design may require increased cooling. For example, flatter portions of the injection mold 36 may use greater cooling than curved detailed portions, which may utilize a lower cooling temperature to allow the solidifying viscous combination to capture all of the detailed structures formed in the injection mold 36. In some embodiments, the injection mold 36 may be cooled for a predetermined time between 100 and 240 seconds and preferably 120 seconds. In some embodiments, the injection mold 36 may be designed so there are no pins or narrow cylinders in the hollow cavity 42 which cannot be actively cooled. Such pins or cylinders may superheat if there is no cooling and puncture the part formed from the solidifying viscous combination and foaming action of the blowing agent while the part is being ejected. Puncturing the part may cause the part to deflate and deform by forming a large air pocket in the part as the distribution of the hollow cells collapses.

Following the cooling, the monolithically structured part formed from the solidifying viscous combination and the foaming action of the blowing agent may be ejected from the injection mold 36, as indicated in step 116.

In some embodiments, the standard injection molding machine 20 melting the mixture into the viscous combination may include feeding the mixture through the barrel 22 including multiple heating zones having respective temperature settings. In the embodiments where the barrel heating mechanism 30 includes the individual heating bands, the individual bands may each be configurable to set the respective temperature of a respective one of the multiple heating zones. The use of multiple heating zones may allow for precise melting of the mixture to maximize the foaming action of the blowing agent for different plastic resins having different melt points. For example, polypropylene material has a typical melting point between 226 and 340 degrees F., while preferably a polypropylene material with an industry standard melt point number of 13 may be used, low density polyethylene material has a typical melting point between 221 to 239 degrees F., while preferably a low density polyethylene material with an industry standard melt point number of 10 may be used, and high density polyethylene material has a typical melting point between 248 to 256 degrees F., while preferably a high density polyethylene material with an industry standard melt point number of 16 may be used. Choosing the correct melt point may ensure strong inner cell lining strength and also allow for better foaming out of the viscous combination throughout the entire hollow cavity 42. For example, if the melt point of the plastic chosen is too high, meaning the material is too thin like water when melted, then the interior cell structure will not have enough plastic material to support the hollow cells. In contrast, if the melt point is too low, meaning the material is thick like oil when melted, the plastic mixture may be too thick or viscous to allow the hollow cells to form in the hollow cavity 42. In some embodiments employing low density polyethylene with a standard industry melt point of 10, a first zone closest to the nozzle 34 of the standard injection molding machine 20 may be set to 300 degrees Fahrenheit, a second zone adjacent to the first zone may be set to 315 degrees Fahrenheit, a third zone adjacent to the second zone may be to 315 degrees Fahrenheit, and a fourth zone adjacent to the third zone may be set to 290 degrees Fahrenheit. In some embodiments employing polypropylene with a standard industry standard melt point of 13, the first zone may be 345 degrees Fahrenheit, the second zone may be 325 degrees Fahrenheit, the third zone may be 315 degrees Fahrenheit, and the fourth zone may be degrees Fahrenheit.

Referring now to FIG. 3B, a flow diagram for an additional or alternative method 200 for manufacturing an injection molded plastic part using the standard injection molding machine 20 is shown. The mold 36 may be secured into the standard injection molding machine 20 with the first half 38 secured to the movable platen 24, as indicated in step 202. Four respective heating zones of the barrel 22 may be heated to respective set temperatures, as indicated in step 204. Responsive to the four respective heating zones achieving the respective set temperatures, the mixture of unmelted plastic resin, talc or glass bubbles, and blowing agent may be fed into the barrel 22 in order to allow plasticization of the mixture into a viscous combination, as indicated in step 206. In some embodiments, the mixture may be precisely mixed using a computer controlled Conair cyclone mixer and then fed into feeder mechanism 28. In some embodiments, in response to the four heating bands achieving the respective set temperatures, a gate may automatically activate to feed the mixture from the feeder mechanism 28 into the barrel 22.

As shown in FIG. 3B, a mold cycle may begin by rotating the feed screw 32 inside the barrel 22 to an initial shot size, as indicated in step 208. In some embodiments, the initial shot size may be a full 11 inches or 62.4 fluid ounces shot size of the standard injection molding machine 20. Various additional shot sizes are contemplated between a range of 9.25 inches and 12 inches. In some embodiments, the shot size may be varied up or down in 0.05 or 0.10 inch increments to account for atmospheric conditions such as barometric pressure, temperature, and humidity. For example, a higher level of humidity may require a higher initial shot size to ensure the blowing agent forms the solidifying viscous combination into a complete monolithically structured part. The movable platen 24 may be moved to a first set point fully opening the first half 38 of the mold 36 and the second half 40 of the mold 36, as indicated in step 210. In some embodiments, the first half 38 of the mold 36 may be 18 inches away from the second half 40 of the mold 36 at the first set point.

As shown in FIG. 3B, the nozzle 34 may be moved forward until the nozzle 34 is seated up against sprue cavity 27, as indicated in step 212. In some embodiments, the nozzle 34 includes a large diameter semi-conical injector nozzle. A larger nozzle configuration may allow for better flow of the viscous combination into the mold 36 and the hollow cavity 42 and may improve the surface appearance of the monolithically structured part and provide a more homogeneous distribution of the hollow cells. In some embodiments, the sprue cavity 27 may include a tapered transition into the hollow cavity 42, a large a sprue diameter, and no stepdown transition along the sprue cavity 27. These features may maximize flow of the viscous combination into mold 36 while minimizing turbulence. In some embodiments, the interface geometry of the sprue cavity 27 may be circular to lower the injection velocity so as to maximize the foaming process created by the blowing agent.

As shown in FIG. 3B, the movable platen 24 may be moved from the first set point to a second set point at a first rate and a first pressure, as indicated in step 214. The movable platen 24 may be moved from the second set point to fully closed at a second rate and a second pressure as indicated in step 216. In some embodiments, the first half 38 of the mold 36 may be 5 inches away from the second half 40 of the mold 36 at the second set point. In some embodiments, the first rate may be 10 in/sec, the first pressure maybe 2000 psi, the second rate may be 7 in/sec, and the second pressure may be 1000 psi. The feeder screw 32 may be pushed ahead towards the nozzle 34 at a third rate and a third pressure for a first preset time period to inject the viscous combination into the mold 36 until the mold 36 is at least partially filled, as indicated in step 218. In some embodiments, the third rate may be 5.79 in/sec, the third pressure may be 2000 psi, and the first preset time period may be 2.35 seconds.

As shown in FIG. 3B, when the feeder screw 32 reaches a cutoff distance from the nozzle, the first half 38 of the mold 36 and the second half 40 of the mold 36 may be held open at a distance for a second preset time period at a low pressure to allow the blowing agent to expand the viscous mixture and fill out the rest of the mold 36, as indicated in step 220. In some embodiments, the distance may be between 0.005 and 0.015 inches, the low pressure may be between 3 and 8 psi, and the second preset time period may be between 20 and 60 seconds. In some embodiments, the distance may be 0.01 inches, the low pressure may be 5 psi, and the second preset time period may be 40 seconds. In some embodiments, the cutoff distance may be approximately 0.05 inches. Furthermore, the mold 36 may be cooled for a predetermined time, as indicated in step 222. Following expiration of the predetermined time, the part formed from the solidifying of the expanded viscous mixture may be ejected from the mold 36, as indicated in step 224. In some embodiments, when the mold 36 is fully open and an open limit switch is activated, an ejector cylinder may push a knockout pin that is resting against an ejector plate of the mold 36 forward at 2.5 in/sec and 250 psi until the knockout pin reaches 0.75 inches. Care is required during the ejection of the part to ensure an initial low impact transition from the mold 36 to a cooling rack or water bath. A low impact transition reduces any action that would cause jarring which could impact the internal structure of the part. The larger parts are more susceptible to jarring and greater care may be taken. Smaller parts may be able to take more of an impact when being ejected from the mold without internal structural damage. In some embodiments, a net, padded cradle, or hammock may be made and affixed below the mold 36 to catch the part as it exits the mold 36 and provide some shock absorption. Furthermore, the knockout pin may be designed to achieve partial ejection with the remaining part removal achieved using robotic arm assistance.

In some embodiments, the feeder screw 32 may be retracted from the nozzle 34 at 160 rpm and 5 psi so that a fresh batch of the mixture can be introduced into the barrel 22 at the beginning of a next mold cycle. A rotate delay may also be added to reduce the amount of time the mixture and/or the viscous combination spends in the barrel 22. In some embodiments, the rotate delay may be 100 seconds. In some embodiments, the nozzle 34 may include a shut off valve that may be activated following injection of the viscous combination into the mold 36 to prevent the viscous combination from drooling or oozing out of the nozzle 34. In some embodiments, the nozzle 34 may be a Herzog type BHP Machine Shutoff Nozzle, which has proven effective in preventing oozing in larger barrels sizes used to create large parts requiring a larger amount of molten plastic.

Upon ejection from the mold 36, the part may be further cooled immediately. The larger the part is, the more important it is to cool the larger volumes of the part. Smaller parts can be completely submerged in a cooling water bath. Larger parts can be floated on one side of the part in a cooling tub of chilled water while the part above water is cooled using chilled water dripped, dispersed, or sprayed onto the part. Air cooling the part is also possible with a fan but may be limited to smaller part sizes. Typical cooling times for parts left in cooling water baths depend on the part size but ranges typically from 20-45 minutes. Parts may be placed on racks or shelves for sorting as needed. For example, while the next cycle of the standard injection molding machine 20 is running, the part may be placed into a water cooling tank to continue the curing process. After 25 minutes of the part being in the water cooling tank, the part may be transferred to an air cooling rack. After a few hours on the air cooling rack, the part may be placed into a box ready to ship to a customer.

In some embodiments, the hollow cavity 42 may include part inserts that may be molded into the monolithic structure of the finished part. The part inserts may be designed or fabricated to include no sharp edges that would poke or damage the internal hollow cell structure of the solidifying viscous combination. Additionally, the part inserts may be designed to allow the solidified and foamed out viscous combination to encapsulate the part inserts.

The methods described herein may produce monolithic injection molded plastic parts for a wide variety of uses. For example, an integrated surface and crush portion for a car bumper, floating buoys for research or warning, highway barricades and lane guards, duck decoys, bumper supports, highway guardrail support blocks, cellular floatation blocks, anti-ballistic sections that can be stacked or interlocked side by side, frame parts of automobiles, machinery, substitute for rubber parts, Styrofoam parts, 2 part foam parts, tires, bushings, and insulating parts for electricity insulation and for temperature insulation such as a drink container cozy or cooler, etc. are specifically contemplated. However, many currently manufactured plastic or combination metal surface foam interior parts may be replaced by a single or multiple joined together monolithic injection molded plastic parts manufactured according to the methods described herein.

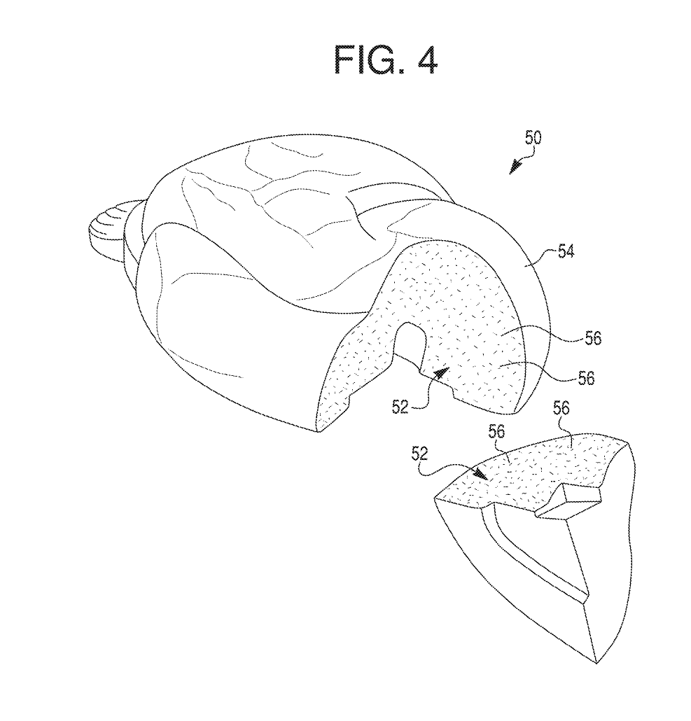

FIG. 4 shows a monolithic injection molded plastic part 50 that may be molded using one of the manufacturing methods disclosed herein. Part 50 may include an interior core 52 and a surface 54 formed as a monolithic structure with the interior core 52. The interior core may substantially fill the entire surface and may include a distribution of hollow cells 56 formed during an injection molding process from a blowing agent. In some embodiments, the surface 54 includes an outer skin having self-healing characteristics and a high surface detail and texture. In some embodiments, the monolithic structure of the interior core 52 and the surface 54 may be formed from one of polypropylene, low density polyethylene, and high density polyethylene. In some embodiments, the hollow cells 56 may have a closed construction. The closed construction may allow the monolithic injection molded plastic part 50 to float in water or similar density liquid after a portion of the monolithic injection molded plastic part 50 is removed or damaged. In some embodiments, the hollow cells 56 may form a honeycomb structure or may resemble a cross section of a bone or a coral sponge. The interior core 52 may extend monolithically from the surface 54 to a geometric center of the monolithic injection molded plastic part 50 and the hollow cells 56 may be disbursed throughout the entirety of the interior core 52 from the geometric center to the surface 54. Part 50 is a monolithic structure formed on plastic injection molding equipment.

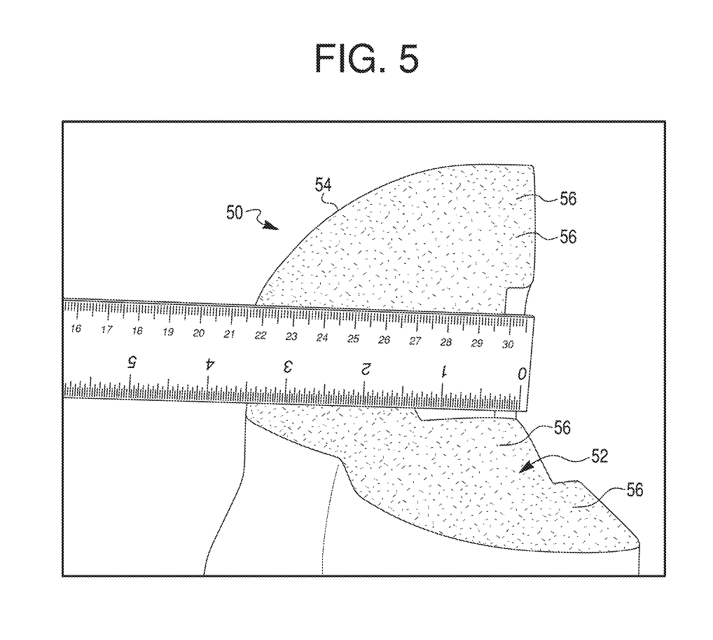

Referring now to FIG. 5, a close up of the monolithic injection molded plastic part 50 is shown. Part 50 may be formed into a single uniform piece having a large cross section and a non-hollow interior. The monolithic structure of the interior core 52 and the surface 54 may have a largest measured thickness, from one periphery of the monolithic structure to another periphery, that is greater than ½ an inch thick, and preferably in the range of ½ an inch to 17 inches. Various embodiments of the monolithic structure of the interior core 52 and the surface 54 having a largest measured thickness greater than 17 inches may be manufactured using the methods described herein in conjunction with larger mold sizes and corresponding adjustments to the method steps to account for the larger mold size as described herein (e.g. the use of glass bubbles rather than talc for greater heat exchange). In some embodiments, the monolithic structure of the interior core 52 and the surface 54 may have a density in the range of 3 pounds per cubic foot to 45 pounds per cubic foot. In some embodiments where talc is used in the manufacturing process, the monolithic structure of the interior core 52 and the surface 54 may have a density in the range of 4 pounds per cubic foot to 45 pounds per cubic foot and preferably in the rage of 19 pounds per cubic foot to 22 pounds per cubic foot. In some embodiments where the glass bubbles are used in the manufacturing process, the monolithic structure of the interior core 52 and the surface 54 may have a density in the range of 3 pounds per cubic foot to 30 pounds per cubic foot and preferably in the rage of 8 pounds per cubic foot to 18 pounds per cubic foot. The formation of the hollow cells 56 throughout the interior core 52 may reduce the overall weight of the monolithic injection molded plastic part 50 when compared to a weight of a solid plastic part having an identical size and shape as the monolithic structure of the interior core 52 and the surface 54. In some embodiments the weight reduction may be in the range of 30 percent to 75 percent. In some embodiments, the hollow cells 56 may provide buoyancy for the monolithic injection molded plastic part 50.

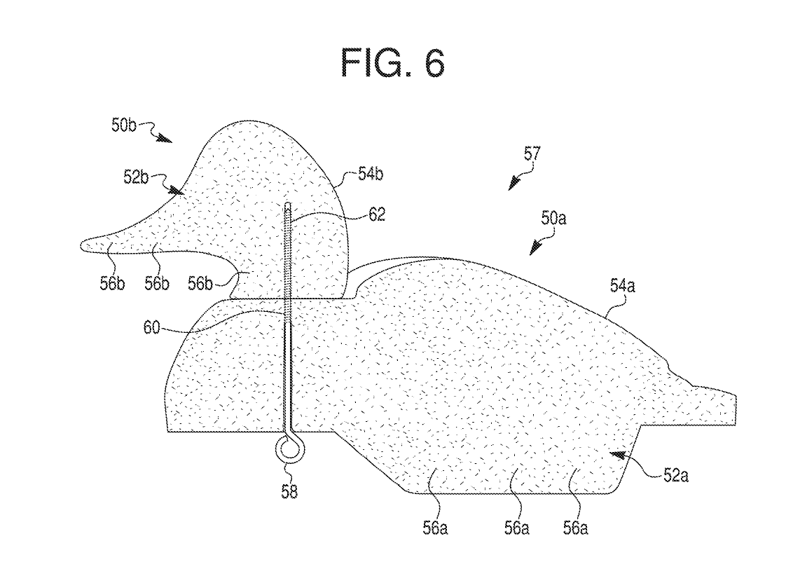

Referring now to FIG. 6, a multi piece part 57 is shown. The multi piece part 57 may include a first monolithically molded plastic piece 50a, a second monolithically molded plastic piece 50b, and a fastener 58. The first monolithically molded plastic piece 50a may have a first interior core 52a and a first surface 54a formed as a monolithic structure with the first interior core 52a. The first interior core 52a may include a first distribution of hollow cells 56a foamed during an injection molding process from a first blowing agent. The second monolithically molded plastic piece may have a second interior core 52b and a second surface 54b formed as a monolithic structure with the second interior core 52b. The second interior core 52b may include a second distribution of hollow cells 56b formed during an injection molding process from a second blowing agent. The fastener 58 may have a first end 60 coupled to the first distribution of hollow cells 56a inside the first monolithically molded plastic piece 50a and a second end 62 coupled to the second distribution of hollow cells 56b inside the second monolithically molded plastic piece 50b. The first distribution of hollow cells 56a may directly grip the first end 60 of the fastener 58 and the second distribution of hollow cells 56b may directly grip the second end 62 of the fastener 58.

In some embodiments, the first monolithically molded plastic piece 50a may have a first density different than a second density of the second monolithically molded plastic piece 50b. In some embodiments, the first monolithically molded plastic piece 50a may be manufactured from a different polymer material than the second monolithically molded plastic piece 50b. For example, some embodiments of the first monolithically molded plastic piece 50a may be made from low density polyethylene with the first density between 16.8 and 18.8 lb/ft³, and some embodiments of the second monolithically molded plastic piece 50b may be made from polypropylene with the second density between 7.7 and 9.7 lb/ft³. In some embodiments, the first density of the first monolithically molded plastic piece 50a may be approximately 17.8 lb/ft³ and the second density of the second monolithically molded plastic piece 50a may be approximately 8.7 lb/ft³.

### EXAMPLES

The following examples are intended to further illustrate the process of this invention and are not intended to limit the scope of the invention in any manner.

### Example 1

A mold was bolted into a 1998 VanDorn 650 (model 650-RS-80F-HT) injection molding machine using toe clamps. A clamping force was the set when a clamping cylinder attached to a movable platen of the machine was all the way forward. A die height motor was used to adjust the movable platen forward so that the two halves of the mold were just touching. Colormaster black low density polyethylene pellets (BK1601E) with an industry standard melt point of 10 and premixed with 10% by volume of 3M iM16K glass bubbles and 1.5% by volume of Hydrocerol® BIH70 chemical blowing agent were loaded into a material hopper of the machine and an additional 0.5-1% by volume of the blowing agent was added. External heating bands on a barrel of the machine were then turned on to begin heating the barrel in order to allow the plasticization of the mixture. This machine has four heating zones. Starting at the nozzle of the barrel and working away (upstream), the temperatures were set to 300, 315, 315, and 290 degrees Fahrenheit respectively. After the heating bands achieved the set temperatures, a gate was pulled from under the material hopper attached to the press to allow the mixture to be gravity feed into a hole in the top of the barrel. The machine was then set to purge out and a screw inside the barrel was rotated back to the full shot size of 11 inches or 62.4 fluid ounces and then the mold cycle began. The mold halves, one on the movable platen and one on the stationary platen, were fully opened to a set point of 18 inches. An injection carriage of the machine was then moved forward until a nozzle of the barrel was seated up against a sprue of the mold. The machine was then transitioned into a semi-automatic mode. The moveable platen then started to move from the fully open 18 inches to 5 inches open at 10 in/sec and 2000 psi. The movable platen then slowed down to 7 in/sec and 1000 psi from 5 inches open to fully closed. Once a closed limit switch was sensed, the injection part of the overall cycle began. A hydraulic shutoff nozzle opened to allow the injection of the now plasticized mixture into the mold. The first injection or mold fill part of the cycle started by pushing the screw ahead towards the nozzle at 5.79 in/sec and 2000 psi for 2.35 seconds, thereby injecting the molten plasticized mixture into the mold until most the mold was filled. The cycle switched at a cutoff of distance of 0.05 inches between a tip of the screw and the nozzle to a hold/pack portion for 40 seconds at 5 psi in order for the rest of the mold to be filled by the foaming action of the solidifying plasticized mixture and the surface quality of the finished part to be achieved.

When the hold/pack portion was over, a cooling stage of the cycle began. To help with this stage in the cycle, the mold had water running through it at 100 degrees Fahrenheit on the movable side and 50 degrees Fahrenheit on the stationary side. During the 120 seconds of cooling, the screw started to rotate and retract at 160 rpm and 5 psi away from the nozzle so that more of the mixture could be introduced into the barrel for the next shot. A rotate delay of 100 seconds was added to reduce the amount of time the mixture spent in the barrel. The reverse rotation of the screw began when the screw reached the shot size of 11 inches or 62.4 fluid ounces. The speed of the reverse rotation of the screw was the total speed reduced by 5 percent, which produced 500 psi of suck back pressure on the molten plastic material in the barrel until the screw was drawn back 0.05 inches into the barrel. The small amount of suck back allowed extra expansion in the part to provide surface detail by pushing out the air between the surface interface of the part and the mold to help prevent “air-lock”, where a small thickness of air trapped around the part and the mold prevents the part from fully expanding against the mold walls to show the surface details onto the surface of the part. The hydraulic shutoff nozzle then closed to prevent the material from drooling or oozing out of the nozzle tip. When the cooling timer was complete, the mold began to open from fully closed to 2 inches open at the rate of 15in/sec and with 2000 psi of outward pressure, then from 2 inches to 17 inches open at the rate 10 in/sec and with 2000 psi of outward pressure, and finally from 17 inches to the fully open 18 inches at the rate of 1 in/sec and with 2000 psi of outward pressure.

When the mold was fully open and an open limit switch was triggered, the ejection of the part began. An ejector cylinder pushed a knockout pin that was resting against the mold's ejector plate forward at 2.5 in/sec and 250 psi until it reached 0.75 inches. The safety door of the machine was then opened to remove the part. Once the door was shut again, the ejector plate and the ejector cylinder retracted to the zero position at 0.5 in/sec and 500 psi. When the ejector cylinder was back and reading zero, the entire 180 second molding cycle began again. While the next cycle was running, the part was placed into a water cooling tank having water at a temperature in the range of 35 to 45 degrees F. to help the part continue to cure. After 25 minutes of the part being in the water cooling tank, the part was removed and a runner was clipped off of the part and then the part was placed on an air cooling rack. After a few hours on the air cooling rack, the part was ready for shipment to a customer.

The specific process described above produced a monolithic plastic part with a weight of approximately 3 pounds, a volume of approximately 291.15 cubic inches, a density of approximately 17.8 pounds per cubic foot, and a buoyant force of approximately 46.8 Newtons.

### Example 2

A mold was bolted into either a 1996 VanDorn 300 (model 300-RS-30F-HT) or a 2001 TOYO 300 (model TM-300H) injection molding machine using toe clamps. A clamping force was the set when a clamping cylinder attached to a movable platen of the machine was all the way forward. A die height motor was used to adjust the movable platen forward so that the two halves of the mold were just touching. Colormaster black polypropylene pellets (BK1601E) with an industry standard melt point of 13 and premixed with 10% by volume 3M iM16K glass bubbles and 1.5% by volume Hydrocerol® BIH70 chemical blowing agent were loaded into a material hopper of the machine and an additional 0.5-1% by volume of the blowing agent was added. External heating bands on a barrel of the machine were then turned on to begin heating the barrel in order to allow the plasticization of the mixture. This machine has 4 heating zones. Starting at the nozzle of the barrel and working away the temperatures were set to 345, 325, 315, and 315 degrees Fahrenheit respectively. After the heating bands achieved the set temperatures, a gate was pulled from under the material hopper attached to the press to allow the mixture to be gravity feed into a hole in the top of the barrel. The machine was then set to purge out and a screw inside the barrel was rotated back to the full shot size of 11 inches or 62.4 fluid ounces and then the mold cycle began. The mold halves, one on the movable platen and one on the stationary platen, were fully opened to a set point of 18 inches. An injection carriage of the machine was then moved forward until a nozzle of the barrel was seated up against a sprue of the mold. The machine was then transitioned into a semi-automatic mode. The moveable platen then started to move from the fully open 18 inches to 5 inches open at 10 in/sec and 2000 psi. The movable platen then slowed down to 7in/sec and 1000 psi from 5 inches open to fully closed. Once a closed limit switch was sensed, the injection part of the overall cycle began. A hydraulic shutoff nozzle opened to allow the injection of the now plasticized mixture into the mold. The first injection or mold fill part of the cycle started by pushing the screw ahead towards the nozzle at 5.79 in/sec and 2000 psi for 2.35 seconds, thereby injecting the molten plasticized mixture into the mold until most the mold was filled. The cycle switched at a cutoff distance of 0.05 inches between a tip of the screw and the nozzle to a hold/pack portion for 40 seconds at 5 psi in order for the rest of the mold to be filled by the foaming action of the solidifying plasticized mixture and the surface quality of the finished part to be achieved.

When the hold/pack portion was over, a cooling stage of the cycle began. To help with this stage in the cycle, the mold had water running through it at 100 degrees Fahrenheit on the movable side and 50 degrees Fahrenheit on the stationary side. During the 120 seconds of cooling, the screw started to rotate and retract at 160 rpm and 5 psi away from the nozzle so that more of the mixture could be introduced into the barrel for the next shot. A rotate delay of 100 seconds was added to reduce the amount of time the mixture spent in the barrel. The reverse rotation of the screw began when the screw reached the shot size of 11 inches or 62.4 fluid ounces. The speed of the reverse rotation of the screw was the total speed reduced by 5 percent, which produced 500 psi of suck back pressure on the molten plastic material in the barrel until the screw was drawn back 0.05 inches into the barrel. The small amount of suck back allowed extra expansion in the part to provide surface detail by pushing out the air between the surface interface of the part and the mold to help prevent “air-lock”, where a small thickness of air trapped around the part and the mold prevents the part from fully expanding against the mold walls to show the surface details onto the surface of the part. The hydraulic shutoff nozzle then closed to prevent the material from drooling or oozing out of the nozzle tip. When the cooling timer was complete, the mold began to open from fully closed to 2 inches open at the rate of 15 in/sec and with 2000 psi of outward pressure, then from 2 inches to 17 inches open at the rate 10 in/sec and with 2000 psi of outward pressure, and finally from 17 inches to the fully open 18 inches at the rate of 1 in/sec and with 2000 psi of outward pressure.

When the mold was fully open and an open limit switch was triggered, the ejection of the part began. An ejector cylinder pushed a knockout pin that was resting against the mold's ejector plate forward at 2.5 in/sec and 250 psi until it reached 0.75 inches. The safety door of the machine was then opened to remove the part. Once the door was shut again the ejector plate and the ejector cylinder retracted to the zero position at 0.5 in/sec and 500 psi. When the ejector cylinder was back and reading zero, the entire 180 second molding cycle began again. While the next cycle was running, the part was placed into a water cooling tank having water at a temperature in the range of 35 to 45 degrees F. to help the part continue to cure. After 25 minutes of the part being in the water cooling tank, the part was removed and a runner was clipped off of the part and then the part was placed on an air cooling rack. After a few hours on the air cooling rack, the part was ready for shipment to a customer.

The specific process described above produced a monolithic plastic part with a weight of approximately 0.25 pounds, a volume of approximately 49.6 cubic inches, a density of approximately 8.7 pounds per cubic foot, and a buoyant force of approximately 7.97 Newtons.

### Example 3

A mold was bolted into a 1998 VanDorn 650 (model 650-RS-80F-HT) injection molding machine using toe clamps. A clamping force was the set when a clamping cylinder attached to a movable platen of the machine was all the way forward. A die height motor was used to adjust the movable platen forward so that the two halves of the mold were just touching. Colormaster black low density polyethylene pellets (BK1601E) with an industry standard melt point of 10 and premixed with 15% by volume talc and 1.5% by volume Hydrocerol® BIH70 chemical blowing agent were loaded into a material hopper of the machine and an additional 0.5-1% by volume of the blowing agent was added. External heating bands on a barrel of the machine were then turned on to begin heating the barrel in order to allow the plasticization of the mixture. This machine has 4 heating zones. Starting at the nozzle of the barrel and working away the temperatures were set to 300, 315, 315, and 290 degrees Fahrenheit respectively. After the heating bands achieved the set temperatures, a gate was pulled from under the material hopper attached to the press to allow the mixture to be gravity feed into a hole in the top of the barrel. The machine was then set to purge out, and a screw inside the barrel was rotated back to the full shot size of 11 inches or 62.4 fluid ounces and then the mold cycle began. The mold halves, one on the movable platen and one on the stationary platen, were fully opened to a set point of 18 inches. An injection carriage of the machine was then moved forward until a. nozzle of the barrel was seated up against a sprue of the mold. The machine was then transitioned into a semi-automatic mode. The movable platen then started to move from the fully open 18 inches to 5 inches open at 10 in/sec and 2000 psi. The movable platen then slowed down to 7 in/sec and 1000 psi from 5 inches open to fully closed. Once a closed limit switch was sensed, the injection part of the overall cycle began. A hydraulic shutoff nozzle opened to allow the injection of the now plasticized mixture into the mold. The first injection or mold fill part of the cycle started by pushing the screw ahead towards the nozzle at 5.79 in/sec and 2000 psi for 2.35 seconds, thereby injecting the molten plasticized mixture into the mold until most the mold was filled. The cycle switched at a cutoff of distance of 0.05 inches between a tip of the screw and the nozzle to a hold/pack portion for 40 seconds at 5 psi in order for the rest of the mold to be filled by the foaming action of the solidifying plasticized mixture and the surface quality of the finished part to be achieved.

When the hold/pack portion was over, a cooling stage of the cycle began. To help with this stage in the cycle, the mold had water running through it at 100 degrees Fahrenheit on the movable side and 50 degrees Fahrenheit on the stationary side. During the 120 seconds of cooling the screw started to rotate and retract at 160 rpm and 5 psi away from the nozzle so that more of the mixture could be introduced into the barrel for the next shot. A rotate delay of 100 seconds was added to reduce the amount of time the mixture spent in the barrel. The reverse rotation of the screw began when the screw reached the shot size of 11 inches or 62.4 fluid ounces. The speed of the reverse rotation of the screw was the total speed reduced by 5 percent, which produced 500 psi of suck back pressure on the molten plastic material in the barrel until the screw was drawn back 0.05 inches into the barrel. The small amount of suck back allowed extra expansion in the part to provide surface detail by pushing out the air between the surface interface of the part and the mold to help prevent “air-lock”, where a small thickness of air trapped around the part and the mold prevents the part from fully expanding against the mold walls to show the surface details onto the surface of the part. The hydraulic shutoff nozzle then closed to prevent the material from drooling or oozing out of the nozzle tip. When the cooling timer was complete, the mold began to open from fully closed to 2 inches open at the rate of 15 in/sec and with 2000 psi of outward pressure, then from 2 inches to 17 inches open at the rate 10 in/sec and with 2000 psi of outward pressure, and finally from 17 inches to the fully open 18 inches at the rate of 1 in/sec and with 2000 psi of outward pressure.

When the mold was fully open and an open limit switch was triggered, the ejection of the part began. An ejector cylinder pushed a knockout pin that was resting against the mold's ejector plate forward at 2.5 in/sec and 250 psi until it reached 0.75 inches. The safety door of the machine was then opened to remove the part. Once the door was shut again, the ejector plate and the ejector cylinder retracted to the zero position at 0.5 in/sec and 500 psi. When the ejector cylinder was back and reading zero, the entire 180 second molding cycle began again. While the next cycle was running, the part was placed into a water cooling tank having water at a temperature in the range of 35 to 45 degrees F. to help the part continue to cure. After 25 minutes of the part being in the water cooling tank, the part was removed and a runner was clipped off of the part and then the part was placed on an air cooling rack. After a few hours on the air cooling rack, the part was ready for shipment to a customer.

The specific process described above produced a monolithic plastic part with a weight of approximately 3.7 pounds, a volume of approximately 291.15 cubic inches, a density of approximately 21.96 pounds per cubic foot, and a buoyant force of approximately 46.8 Newtons.

### Example 4

A mold was bolted into either a 1996 VanDorn 300 (model 300-RS-30F-HT) or a 2001 TOYO 300 (model TM-300H) injection molding machine using toe clamps. A clamping force was the set when a clamping cylinder attached to a movable platen of the machine was all the way forward. A die height motor was used to adjust the movable platen forward so that the two halves of the mold were just touching. Colormaster black polypropylene pellets (BK1601E) with an industry standard melt point of 13 and premixed with 20% by volume talc and 1.5% by volume Hydrocerol® BIH70 chemical blowing agent were loaded into a material hopper of the machine and an additional 0.5-1% by volume of the blowing agent was added. External heating bands on a barrel of the machine were then turned on to begin heating the barrel in order to allow the plasticization of the mixture. This machine has 4 heating zones. Starting at the nozzle of the barrel and working away the temperatures were set to 345, 325, 315, and 315 degrees Fahrenheit respectively. After the heating bands achieved the set temperatures, a gate was pulled from under the material hopper attached to the press to allow the mixture to be gravity feed into a hole in the top of the barrel. The machine was then set to purge out and a screw inside the barrel was rotated back to the full shot size of 11 inches or 62.4 fluid ounces and then the mold cycle began. The mold halves, one on the movable platen and one on the stationary platen, were fully opened to a set point of 18 inches. An injection carriage of the machine was then moved forward until a nozzle of the barrel was seated up against a sprue of the mold. The machine was then transitioned into a semi-automatic mode. The movable platen then started to move from the fully open 18 inches to 5 inches open at 10 in/sec and 2000 psi. The movable platen then slowed down to 7 in/sec and 1000 psi from 5 inches open to fully closed. Once a closed limit switch was sensed, the injection part of the overall cycle began. A hydraulic shutoff nozzle opened to allow the injection of the now-plasticized mixture into the mold. The first injection or mold fill part of the cycle started by pushing the screw ahead towards the nozzle at 5.79 in/sec and 2000 psi for 2.35 seconds, thereby injecting the molten plasticized mixture into the mold until most of the mold was filled. The cycle switched at a cutoff distance of 0.05 inches between a tip of the screw and the nozzle to a hold/pack portion for 40 seconds at 5 psi in order for the rest of the mold to be filled by the foaming action of the solidifying plasticized mixture and the surface quality of the finished part to be achieved.

When the hold/pack portion was over, a cooling stage of the cycle began. To help with this stage in the cycle the mold had water running through it at 100 degrees Fahrenheit on the movable side and 50 degrees Fahrenheit on the stationary side. During the 120 seconds of cooling the screw started to rotate and retract at 160 rpm and 5 psi away from the nozzle so that more of the mixture could be introduced into the barrel for the next shot. A rotate delay of 100 seconds was added to reduce the amount of time the mixture spent in the barrel. The reverse rotation of the screw began when the screw reached the shot size of 11 inches or 62.4 fluid ounces. The speed of the reverse rotation of the screw was the total speed reduced by 5 percent, which produced 500 psi of suck back pressure on the molten plastic material in the barrel until the screw was drawn back 0.05 inches into the barrel. The small amount of suck back allowed extra expansion in the part to provide surface detail by pushing out the air between the surface interface of the part and the mold to help prevent “air-lock”, where a small thickness of air trapped around the part and the mold prevents the part from fully expanding against the mold walls to show the surface details onto the surface of the part. The hydraulic shutoff nozzle then closed to prevent the material from drooling or oozing out of the nozzle tip. When the cooling timer was complete, the mold began to open from fully closed to 2 inches open at the rate of 15 in/sec and with 2000 psi of outward pressure, then from 2 inches to 17 inches open at the rate 10 in/sec and with 2000 psi of outward pressure, and finally from 17 inches to the fully open 18 inches at the rate of 1 in/sec and with 2000 psi of outward pressure.

When the mold was fully open and an open limit switch was triggered, the ejection of the part began. An ejector cylinder pushed a knockout pin that was resting against the mold's ejector plate forward at 2.5 in/sec and 250 psi until it reached 0.75 inches. The safety door of the machine was then opened to remove the part. Once the door was shut again the ejector plate and the ejector cylinder retracted to the zero position at 0.5 in/sec and 500 psi. When the ejector cylinder was back and reading zero, the entire 180 second molding cycle began again. While the next cycle was running, the part was placed into a water cooling tank having water at a temperature in the range of 35 to 45 degrees F. to help the part continue to cure. After 25 minutes of the part being in the water cooling tank, the part was removed and a runner was clipped off of the part and then the part was placed on an air cooling rack. After a few hours on the air cooling rack, the part was ready for shipment to a customer.

The specific process described above produced a monolithic plastic part with a weight of approximately 0.56 pounds, a volume of approximately 49.6 cubic inches, a density of approximately 19.6 pounds per cubic foot, and a buoyant force of approximately 7.97 Newtons.

### Example 5

A mold was bolted into a TOYO TM-300H injection molding machine using toe clamps. The machine featured a Reiloy Eagle Mixing Screw inside the barrel. The machine featured a TOYO PLCS-9 computer. A clamping force was the set when a clamping cylinder attached to a movable platen of the machine was all the way forward. A die height motor was used to adjust the movable platen forward so that the two halves of the mold were just touching. Colormaster black polypropylene pellets (BK1601E) with an industry standard melt point of 15 and 2.0% by volume Hydrocerol® BIH70 chemical blowing agent chemical blowing agent was prepared and loaded into a material hopper of the machine. External heating bands on a barrel of the machine were then turned on to begin heating the barrel in order to allow the plasticization of the mixture. This machine has 5 heating zones. Starting at the nozzle of the barrel and working away the temperatures were set to 385, 375, 365, 350 and 350 degrees Fahrenheit respectively. After the heating bands achieved the set temperatures, a gate was pulled from under the material hopper attached to the press to allow the mixture to be gravity feed into a hole in the top of the barrel. The machine was then set to purge out and a screw inside the barrel was rotated back to the full shot size of 8.050 inches and then the mold cycle began. The mold halves, one on the movable platen and one on the stationary platen, were fully opened to a set point of 12 inches. An injection carriage of the machine was then moved forward until a nozzle of the barrel was seated up against a sprue of the mold. The machine was set to run in automatic mode because the finished part was smaller part and able to take the stresses and jarring of being automatically ejected from the mold. The moveable platen then started to move from the fully open 12 inches to 4 inches open at 55% of total speed or 2.31 in/sec and 800 psi. The movable platen then slowed down to 15% of total speed or 0.63 in/sec and 50 psi from 4 inches open to fully closed. Once a closed limit switch was sensed, the injection part of the overall cycle began. The first injection or mold fill part of the cycle was started by pushing the screw ahead towards the nozzle at 100% of total speed or 4.20 in/sec and 1500 psi for 2.0 seconds, thereby injecting the molten plasticized mixture into the mold until most the mold was filled. The cycle switched at a cutoff of 0.250 inches between a tip of the screw and the nozzle to a hold/pack portion for 20 seconds at 25 psi in order for the rest of the mold to be filled by the foaming action of the solidifying plasticized mixture and the surface quality of the finished part to be achieved.

When the hold/pack portion was over a cooling stage of the cycle began. To help with this stage in the cycle the mold had water running through it at 80 degrees Fahrenheit on the movable side and 80 degrees Fahrenheit on the stationary side. During the 91 seconds of cooling the screw started to rotate and retract at 110 rpm and 5 psi away from the nozzle so that more of the mixture could be introduced into the barrel for the next shot. A rotate delay of 60 seconds was added to reduce the amount of time the mixture spent in the barrel. The speed of the reverse rotation of the screw was the total speed reduced by 10 percent or 0.42 in.sec which produced 1500 psi of suck back pressure on the molten plastic material in the barrel until the screw was drawn back 0.1 inches into the barrel. The small amount of suck back allowed extra expansion in the part to provide surface detail by pushing out the air between the surface interface of the part and the mold to help prevent “air-lock”, where a small thickness of air trapped around the part and the mold prevents the part from fully expanding against the mold walls to show the surface details onto the surface of the part. The hydraulic shutoff nozzle then closed to prevent the material from drooling or oozing out of the nozzle tip. When the cooling timer was complete, the mold began to open from fully closed to 1.25 inches open at the rate of 10% the total speed or 0.42 in/sec and with 2418 psi of outward pressure, then from 1.25 inches to 10 inches open at the rate 45% the total speed or 1.89in/sec and with 800 psi of outward pressure, and finally from 10 inches to the fully open 12 inches at the rate of 20% the total speed or 0.84 in/sec and with 300 psi of outward pressure.

When the mold was fully open and an open limit switch was triggered, the ejection of the part began. An ejector cylinder pushed a knockout pin that was resting against the mold's ejector plate forward at 25% the total speed or 1.05 in/sec and 500 psi until the knockout pin reached 1.855 inches. The safety door of the machine remained closed in the automatic mode as the part is ejected from the mold. The ejector plate and the ejector cylinder retracted to the zero position at 25% the total speed or 1.05 in/sec and 995 psi. When the ejector cylinder was back and reading zero, the entire 120 second molding cycle began again. While the next cycle was running, the part was placed into a water cooling tank to help the part continue to cure. After 25 minutes of the part being in the water cooling tank, the part was removed and a runner was clipped off of the part and then the part was placed on an air cooling rack. After a few hours on the air cooling rack, the part was ready for shipment to a customer.

The specific process described above produced a set of similar size and shape, monolithic plastic parts connected together via a runner with a total shot weight of approximately 1.22 pounds (part A approx. weight of 0.55 pounds and part B approx. weight of 0.67 pounds). Part A had a volume of approximately 49.6 cubic inches, a density of approximately 19.16 pounds per cubic foot, and a buoyant force of approximately 7.97 Newtons. Part B had a volume of approximately 60.42 cubic inches, a density of approximately 19.16 pounds per cubic foot, and a buoyant force of approximately 9.71 Newtons.

Although a few embodiments have been described in detail above, other modifications are possible within the scope and spirit of the invention. For example, the steps described above do not require the particular order described or sequential order to achieve desirable results. Other steps may be provided, steps may be eliminated from the described flows, and other components may be added to or removed from the described systems. Other embodiments may be within the scope of the invention.

The process disclosed illustratively herein is useful for manufacturing a wide variety of items. Some of the figures show a duck decoy made by the described process. The decoy is, of course, buoyant. It is substantially filled. It is capable of being tapped to receive and support a lag or machine screw (See FIG. 6). The molding process may be used to form a very wide variety of structural elements that can replace traditional metal or plastic parts. The manufactured items produced by the molding process are quite strong, and the molding process could be used for manufacturing automotive parts, industrial parts, architectural elements, poles, supports, aims, struts, beams, plates, planks, rails, girders, supports, slabs, columns, walls, doors, knobs, ornaments, chassis, housings, and scores of other items of manufacture used in numerous industries.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method for manufacturing an injection molded plastic part comprising the steps of:
melting a mixture comprising an unmelted plastic polymer resin, filler agent, and chemical blowing agent into a viscous combination in an injection molding machine;
securing two parts of an injection mold between a first platen and a second platen of the injection molding machine to form a hollow cavity and a gap between the two parts;
injecting a set amount of the viscous combination into the hollow cavity;
holding the set amount of the viscous combination in the hollow cavity at a low pressure for a hold time to permit the viscous combination to set into a monolithic structure at least partially filling the hollow cavity and the chemical blowing agent forms a distribution of hollow cells that extends throughout the monolithic structure;
cooling the two parts of the injection mold; and
ejecting the monolithic structure from the injection mold.

2. The method for manufacturing an injection molded plastic part of claim 1, wherein injecting a set amount of the viscous combination into the hollow cavity includes injecting at a maximum flow rate of the injection molding machine for a time period calculated based on the set amount.

3. The method for manufacturing an injection molded plastic part of claim 2, wherein the time period is between 1.35 and 3.35 seconds.

4. The method for manufacturing an injection molded plastic part of claim 1, wherein the gap between the parts of the injection mold is between 0.005 and 0.015 inches, the low pressure is between 3 and 8 psi, and the hold time is between 20 and 60 seconds.

5. The method for manufacturing an injection molded plastic part of claim 1, wherein the low pressure is 30 percent of a peak flow rate for injecting the set amount of the viscous combination into the hollow cavity.

6. The method for manufacturing an injection molded plastic part of claim 1, wherein cooling the two parts of the injection mold includes cooling each part of the injection mold using water having a different temperature for between 100 and 240 seconds.

7. The method for manufacturing an injection molded plastic part of claim 1, wherein the filler agent comprises glass bubbles.

8. The method for manufacturing an injection molded plastic part of claim 7, wherein the glass bubbles are approximately 10 percent of the mixture by volume.

9. The method for manufacturing an injection molded plastic part of claim 1 further comprising rotating a screw of the standard injection molding machine to a shot size between 9.25 inches and 12 inches prior to melting the mixture.

10. The method for manufacturing an injection molded plastic part of claim 1, further comprising, following the injecting of the set amount of the viscous combination into the hollow cavity, applying a back pressure of between 5 and 20 psi within a barrel used for the injecting of the set amount of the viscous combination into the hollow cavity.

11. The method for manufacturing an injection molded plastic part of claim 1, wherein the chemical blowing agent is between 1 and 5 percent of the mixture by weight.

12. The method for manufacturing an injection molded plastic part of claim 1, wherein the filler agent is talc.

13. The method for manufacturing an injection molded plastic part of claim 1, wherein the talc is approximately 15 percent of the mixture by weight.

14. The method for manufacturing an injection molded plastic part of claim 1, wherein the unmelted plastic polymer resin comprises a plastic polymer material selected from a group consisting of polypropylene, low density polyethylene, high density polyethylene, acrylonitrile butadiene styrene, nylon, fiber-reinforced plastic, rubber, and mixtures thereof.

15. The method for manufacturing an injection molded plastic part of claim 1, wherein the filler agent increases heat transfer of the viscous combination with the injection mold to provide faster cooling and suspension of the viscous combination as an aerated mass that forms the distribution of hollow cells throughout the monolithic structure.

16. A method for manufacturing an injection molded plastic part using an injection molding machine having a mold secured therein, a first part of the mold being secured to a movable platen comprising:
heating multiple heating zones of a barrel of the injection molding machine to respective set temperatures;
after the respective heating zones achieve the respective set temperatures, feeding a mixture comprising an unmelted plastic polymer resin, chemical blowing agent, and glass bubbles into the barrel in order to allow plasticization of the mixture into a viscous combination;
beginning a mold cycle by rotating a feed screw inside the barrel to an initial shot size;
moving the movable platen to a first set point fully opening the first part of the mold and a second part of the mold;
moving the nozzle forward until the nozzle is seated up against a circular sprue of the mold;
moving the movable platen from the first set point to a second set point at a first rate and a first pressure;
moving the movable platen from the second set point to a position holding the first part of the mold and the second part of the mold open at a distance;
pushing the screw ahead toward the nozzle at a second rate and a second pressure for a first preset time period to inject the viscous combination into the mold until the mold is at least partially filled;
when the screw reaches a cutoff distance from the nozzle, holding the first part of the mold and the second part of the mold open at the distance for a second preset time period at a low pressure to allow the chemical blowing agent to expand the viscous combination and fill out the rest of the mold;
cooling the mold for a predetermined time; and
following expiration of the predetermined time, ejecting a part formed from solidifying of the expanded viscous combination from the mold.

17. The method for manufacturing an injection molded plastic part of claim 16, wherein the distance is between 0.005 and 0.015 inches, the low pressure is between 3 and 8 psi, and the second preset time period is between 20 and 60 seconds.

18. The method for manufacturing an injection molded plastic part of claim 16, wherein the barrel size is 80 inches, and wherein the initial shot size is between 9.25 inches and 12 inches of the plastic mixture .

19. The method for manufacturing an injection molded plastic part of claim 16, wherein the first rate is 10 in/sec and the first pressure is 2000 psi.

20. The method for manufacturing an injection molded plastic part of claim 16, wherein the second rate is 5.79 in/sec, the second pressure is 2000 psi, and the first preset time period is 2.35 seconds.

21. The method for manufacturing an injection molded plastic part of claim 16, wherein cooling the mold includes running 100 degree Fahrenheit water through the first part of the mold and 50 degree Fahrenheit water through the second part of the mold.

22. The method for manufacturing an injection molded plastic part of claim 16, wherein the predetermined time is between 100 and 240 seconds.

23. The method for manufacturing an injection molded plastic part of claim 16, wherein the cutoff distance is approximately 0.05 inches.

24. The method for manufacturing an injection molded plastic part of claim 16, wherein the unmelted plastic polymer resin comprises a plastic polymer material selected from a group consisting of polypropylene, low density polyethylene, high density polyethylene, acrylonitrile butadiene styrene, nylon, fiber-reinforced plastic, rubber, and mixtures thereof

25. The method for manufacturing an injection molded plastic part of claim 16, wherein the glass bubbles increase heat transfer of the viscous combination with the mold to provide faster cooling and suspension of the viscous combination as an aerated mass that forms a distribution of hollow cells throughout the part, and wherein the distribution of the hollow cells resemble a cross-section of a bone with smaller sized hollow cells being more concentrated closer to an outer surface of the monolithic structure and larger sized hollow cells being more concentrated closer to a center of the monolithic structure.

26. A method for manufacturing an injection molded plastic part comprising:
loading a mixture comprising an unmelted plastic polymer resin, filler agent, and chemical blowing agent into an injection molding machine;
melting the mixture into a viscous combination in the injection molding machine;
securing two parts of an injection mold to form a hollow cavity;
injecting the viscous combination into the hollow cavity; and
holding the viscous combination in the hollow cavity at a low pressure until the chemical blowing agent expands the viscous combination into the injection molded part that includes a monolithic structure at least partially filling the hollow cavity and a distribution of hollow cells extending throughout the monolithic structure.

27. The method for manufacturing an injection molded plastic part of claim 26, wherein the injection molded part has a largest measured thickness in excess of 0.5 inches.

28. The method for manufacturing an injection molded plastic part of claim 26, wherein the injection molded part has a largest measured thickness in excess of 3 inches.

29. The method for manufacturing an injection molded plastic part of claim 26, wherein the injection molded part has a largest measured thickness that extends in excess of 12 inches.

30. The method for manufacturing an injection molded plastic part of claim 26, further comprising rotating a screw of the standard injection molding machine to a shot size between 9.25 inches and 12 inches prior to melting the mixture.
